(19) United States
(12) Patent Application Publication
(10) Pub. No.: US 2023/0120048 A1
(43) Pub. Date: Apr. 20, 2023

(54) RESIN MOLDED PRODUCT HAVING IMPROVED HYDROLYSIS RESISTANCE AND LASER TRANSMISSION STABILITY, CAMERA MODULE MEMBER INCLUDING THE SAME, AND AUTOMOBILE ELECTRONIC COMPONENT MEMBER INCLUDING THE SAME

(71) Applicants: HYUNDAI MOBIS CO., LTD., Seoul (KR); LG CHEM, LTD., Seoul (KR)

(72) Inventors: Hyoung Taek KANG, Yongin-si (KR); Hyeon Don KIM, Yongin-si (KR); Hee Jae HWANG, Daejeon (KR); Tae Hun KWON, Daejeon (KR); Jae Chan PARK, Daejeon (KR)

(73) Assignees: HYUNDAI MOBIS CO., LTD., Seoul (KR); LG CHEM, LTD., Seoul (KR)

(21) Appl. No.: 17/968,096

(22) Filed: Oct. 18, 2022

(30) Foreign Application Priority Data
Oct. 18, 2021 (KR) 10-2021-0138613

(51) Int. Cl. C08L 67/02

(52) U.S. Cl. CPC C08L 67/02; C08L 2205/025

(57) ABSTRACT

The present invention relates to a resin molded product having excellent laser transmission stability and hydrolysis resistance, a camera module member including the resin molded product, and an automobile electronic component member including the resin molded product, and provides a resin molded product having a laser transmittance of 80% or more of a 1.5 mm-thick rectangular-specimen gate part measured at a wavelength of 980 nm, a flexural strength retention rate of 50% or more, a bonding strength retention rate of 50% or more, and a laser transmittance standard deviation of 20 or less, a camera module member including the resin molded product, and an automobile electronic component member including the resin molded product.

### CROSS-REFERENCE TO RELATED APPLICATIONS

This application claims the priority of Korean Patent Application No. 10-2021-0138613 filed on Oct. 18, 2021 in the Korean Intellectual Property Office, the disclosure of which is incorporated herein by reference.

### TECHNICAL FIELD

The present invention relates to a resin molded product having excellent laser transmission stability and hydrolysis resistance, a camera module member including the resin molded product, and an automobile electronic component member including the resin molded product.

### BACKGROUND

It is very important to form a driving space so that when driving a vehicle, a driver can accurately look to the front, left and right, and rear of the vehicle, and can keep an eye on the proximate position when parking and stopping the vehicle. To this end, the vehicle gets to detect an invisible proximate position with a camera installed inside or behind the vehicle. In particular, the rear camera of the vehicle allows the driver to monitor the blind spot at the rear of the vehicle through the screen, thereby preventing an accident in advance when the vehicle is driven, and ensuring the safety of a passenger.

Such a camera module installed in the vehicle has the highest priority on reliability and stability since a momentary malfunction can have a fatal effect on the life of the passenger, and requires high hydrolysis resistance as well as operational stability under intense cold and intense heat conditions.

Meanwhile, in recent years, a laser welding method has been applied to manufacture camera modules and automobile electronic components for process simplification.

Laser welding may realize watertightness, bonding strength, and the like after bonding, which are higher than conventional ultrasonic welding, electric welding, thermal welding, and the like, and may reduce burrs or dust generation, and thus, has been used to produce a wide range of products such as a polymer system component, a distance sensor, a sensor cover of an electric vehicle, an audio device, and a blood pressure gage.

The laser welding is used to manufacture members of a camera module and an automobile electronic component by bonding a laser transmissive material and a laser absorbing material using a semiconductor laser having a wavelength range of 800-1,100 nm, and in this case, the transmittance of the laser transmissive material is important.

Basically, when the material itself is a transparent resin, for example, an amorphous resin such as polycarbonate or polymethylmethacrylate, which is used as the laser transmissive material, the laser transmissive material has a laser transmittance of 90-100%, which has no problem to be used. However, since heat resistance, chemical resistance, and mechanical strength are low, the amorphous resin is not suitable for components requiring such properties, and thus a polyester-based resin having high thermal performance, excellent chemical resistance, and mechanical properties and exhibiting high transmittance to near-infrared (NIR) laser light has been used.

Polybutylene terephthalate among polyester-based resins has high crystallinity, excellent mechanical strength and heat resistance, excellent dimensional stability against temperature changes, and particularly, excellent electrical properties such as electrical insulation, arc resistance, dielectric breakdown strength due to low water absorption. Accordingly, polybutylene terephthalate has been widely applied to electric and electronic products and interior/exterior components of a vehicle, and recently, has been widely applied as a material requiring laser welding among automobile electronic components.

However, polybutylene terephthalate is a crystalline resin and has a crystal region, and thus there is a limitation in that a laser transmittance is reduced by 30% or less due to refraction and reflection of a laser beam. In addition, in order to increase the laser transmittance of polybutylene terephthalate, even though the transmittance is increased by alloying polyethylene terephthalate or polycarbonate towards prevention of crystal formation, these materials are exposed to moisture to cause hydrolysis problems, and a laser transmittance deviation for each part occurs according to the degree of crystallization or injection pressure during injection, resulting in welding defects.

Therefore, there is a need to develop a material having excellent hydrolysis resistance in which transmittance deviation does not occur even when injection pressure is changed due to a change in size or thickness of a molded product.

### SUMMARY

An aspect of the present invention provides a resin molded product which has excellent laser transmission stability and hydrolysis resistance and may be useful for a camera module member and an automobile electronic component member.

Another aspect of the present invention provides a camera module member including the resin molded product.

Another aspect of the present invention provides an automobile electronic component member including the resin molded product.

According to another aspect of the present invention, there is provided a resin molded product having a laser transmittance of 80% or more of a 1.5 mm-thick rectangular-specimen gate part measured at a wavelength of 980 nm, a flexural strength retention rate satisfying Equation 1 below of 50% or more, a bonding strength retention rate satisfying Equation 2 below of 50% or more, and a laser transmittance standard deviation of 20 or less:

Flexural strength retention rate (%)=[FS₁/FS₀]×100 [Equation 1]

Bonding strength retention rate (%)=[BS₁/BS₀]×100 [Equation 2]

In Equation 1 and Equation 2 above, FS₀ and BS₀ are the flexural strength measured at a speed of 2 mm/min, and the bonding strength measured at a speed of 5 mm/min immediately after preparation of a specimen having a bonding site of 60 mm×1.5 mm (length×width), which is prepared by laser-welding the resin molded product and a laser absorbing member at a wavelength of 980 nm, respectively, and FS₁ and BS₁ are the flexural strength measured at a speed of 2 mm/min, and the bonding strength measured at a speed of 5 mm/min after leaving the specimen having a bonding site of 60 mm×1.5 mm (length×width) at 120° C. and 100% RH for 96 hours, respectively.

According to another aspect of the present invention, there is a camera module member including the resin molded product.

According to another aspect of the present invention, there is an automobile electronic component member including the resin molded product.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 shows an example of a rectangular specimen for measuring a laser transmittance according to an embodiment of the present invention.

### DETAILED DESCRIPTION

Exemplary embodiments of the present invention will now be described in detail with reference to the accompanying drawings.

It will be understood that words or terms used in the description and claims of the present invention shall not be construed as being limited to having the meaning defined in commonly used dictionaries. It will be further understood that the words or terms should be interpreted as having meanings that are consistent with their meanings in the context of the relevant art and the technical idea of the invention, based on the principle that an inventor may properly define the meaning of the words or terms to best explain the invention.

### DEFINITION OF TERMS

As used herein, the term “laser welding (or bonding)” refers to a method of bonding two materials having different transmittance and absorptivity with respect to a specific wavelength, and specifically, when a material having high transmittance for transmitting a laser beam in an infrared region of 800 nm to 1000 nm is placed on a material having high laser absorptivity and the laser beam is irradiated through the material having high transmittance, the laser beam is absorbed on the contact surface of the two materials by the material having high absorptivity, and the material having high transmittance absorbs the energy from the material having high absorptivity by heat conduction to increase a temperature, and the two materials are bonded using the above characteristics.

As used herein, the terms “flexural strength retention rate” and “bonding strength retention rate” respectively refer to a degree of maintaining flexural strength and bonding strength after leaving the specimen for a certain time with respect to flexural strength and bonding strength immediately after manufacturing the specimen.

As used herein, the term “gate part” refers to a gate mark which is a part of a mold on the surface of a resin molded product after molding, particularly, a resin molded product obtained by injection molding.

It will be further understood that the terms “comprising,” “including,” and “having” and the derivatives thereof as used herein, though these terms are particularly disclosed or not, are not intended to preclude the presence or addition of optional components, steps, or processes. In order to avoid any uncertainty, all materials and methods claimed by using the term “comprising” may include optional additional additives, auxiliaries, or compounds, including a catalyst or any other materials, unless otherwise described. In contrast, the term “consisting essentially of” excludes unnecessary ones for operation and precludes optional other components, steps or processes from the scope of optional continuous description. The term “consisting of” precludes optional components, steps or processes, which are not particularly described or illustrated.

### Measurement Methods and Conditions

In the present specification, the “laser transmittance (%)” is a value calculated by Equation 5 below after manufacturing a component cover (rectangular specimen) for USRR having 60 mm (width)×60 mm (length)×1.5 mm (thickness) by injection molding a resin molded product, and emitting a laser beam having a laser irradiation wavelength of 980 nm and an output of 10 mW on the cover (rectangular specimen) using ETM-31 (EV Laser Co., Ltd.), and then measuring a returned intensity value.

T (laser transmittance (%))=100×P_{T}/P₀ [Equation 5]

In Equation 5 above, P_{T} is a laser output (mW) through the specimen, and P₀ is 10 mW.

In the present specification, the “bonding strength” is measured according to the MS216-06 standard. Specifically, a rectangular specimen having a bonding site of 60 mmx 1.5 mm (length×width) is prepared by laser-welding a resin molded product and a laser absorbing member at a wavelength of 980 nm, and a load (pressure) is measured at the time at which the bonding site is separated when a load is applied at a speed of 5 mm/min to the specimen using a UTM device (3367, INSTRON, Co., Ltd.).

In the present specification, the “flexural strength” is measured according to the MS216-06 standard. Specifically, a rectangular specimen having a bonding site of 60 mm×1.5 mm (length×width) is prepared by laser welding a resin molded product and a laser absorbing member at a wavelength of 980 nm, and a load (pressure) is measured at the time when the bonding site is bent and ruptured when the load is applied at a speed of 2 mm/min to the specimen using the UTM device (3367, INSTRON, Co., Ltd.).

### Resin Molded Product

The present invention provides a resin molded product, which has excellent laser transmission stability to enable easy laser welding, and excellent hydrolysis resistance, thereby having excellent long-term durability.

The resin molded product according to an embodiment of the present invention has a laser transmittance of 80% or more of a 1.5 mm-thick rectangular-specimen gate part measured at a wavelength of 980 nm, a flexural strength retention rate, satisfying (or defined by) Equation 1 below, of 50% or more, a bonding strength retention rate, satisfying Equation 2 below, of 50% or more, and a laser transmittance standard deviation of 20 or less.

Flexural strength retention rate (%)=[FS₁/FS₀]×100 [Equation 1]

Bonding strength retention rate (%)=[BS₁/BS₀]×100 [Equation 2]

In Equation 1 and Equation 2 above, FS₀ and BS₀ are the flexural strength measured at a speed of 2 mm/min, and the bonding strength measured at a speed of 5 mm/min immediately after preparation of a specimen having a bonding site of 60 mm×1.5 mm (length×width), which is prepared by laser-welding the resin molded product and a laser absorbing member at a wavelength of 980 nm, respectively, and FS₁ and BS₁ are the flexural strength measured at a speed of 2 mm/min, and the bonding strength measured at a speed of 5 mm/min after leaving the specimen having a bonding site of 60 mm×1.5 mm (length×width) at 120° C. and 100% RH for 96 hours, respectively.

Here, 120° C. and 100% RH are conditions formed using a pressure cooker tester (PCT), which is equipment called HAST.

According to an embodiment of the present invention, the resin molded product has excellent laser transmission stability by satisfying the laser transmittance, the flexural strength retention rate, the bonding strength retention rate, and the laser transmittance deviation at the same time, and thus has a high laser transmittance, a low transmittance deviation, and excellent hydrolysis resistance despite changes in injection conditions, thereby having excellent long-term durability.

Specifically, the resin molded product may have a laser transmittance of 80% or more, specifically, 85% or more of the 1.5 mm-thick rectangular-specimen gate part measured at a wavelength of 980 nm.

In addition, the resin molded product may have a maximum laser transmittance of 90% or more of the 1.5 mm-thick rectangular specimen measured at a wavelength of 980 nm.

Here, the maximum laser transmittance is obtained by measuring the laser transmittance of the other four portions except for the gate part in the rectangular specimen 5 times under the same conditions and calculating an average value thereof.

In addition, the resin molded product may have a laser transmittance standard deviation of 20 or less, specifically 15 or less, 10 or less, or more specifically 5 or less.

In addition, the resin molded product may have a flexural strength retention rate, satisfying Equation 1, of 50% or more and a bonding strength retention rate, satisfying Equation 2, of 50% or more.

In addition, the resin molded product may have a flexural strength retention rate A, satisfying Equation 3 below, of 30% or more, and a bonding strength retention rate A, satisfying Equation 4 below, of 30% or more:

Flexural strength retention rate A (%)=[FS₂/FS₀]×100 [Equation 3]

In Equation 3 above, FS₀ is the flexural strength measured at a speed of 2 mm/min immediately after preparation of a specimen having a bonding site of 60 mm×1.5 mm (length×width), which is prepared by laser-welding a resin molded product and a laser absorbing member at a wavelength of 980 nm, and FS₂ is the flexural strength measured at a speed of 2 mm/min after leaving the specimen having a bonding site of 60 mm×1.5 mm (length×width) at 120° C. and 100% RH for 144 hours.

Bonding strength retention rate A (%)=[BS₂/BS₀]×100 [Equation 4]

In Equation 4 above, BS₀ is the bonding strength measured at a speed of 5 mm/min immediately after preparation of a specimen having a bonding site of 60 mm×1.5 mm (length×width), which is prepared by laser-welding a resin molded product and a laser absorbing member at a wavelength of 980 nm, and BS₂ is the bonding strength measured at a speed of 5 mm/min after leaving the specimen having a bonding site of 60 mm×1.5 mm (length×width) at 120° C. and 100% RH for 144 hours.

In addition, the resin molded product may have a bonding strength of 2500 N or more and a flexural strength of 9000 MPa or more. In this case, the bonding strength and the flexural strength may be measured at a speed of 2 mm/min and a speed of 5 mm/min, respectively, with respect to a specimen having a bonding site of 60 mm×1.5 mm (length×width), which is prepared by laser welding the resin molded product and the laser absorbing member at a wavelength of 980 nm.

Meanwhile, the resin molded product may be an injection molded product of a polyester resin composition containing: a polyester resin including polybutylene terephthalate and polyethylene terephthalate; a filler; a chain extender; a resin modifier; and a catalyst, and may be manufactured by injection molding from the polyester resin composition, thereby satisfying the aforementioned laser transmittance, flexural strength retention rate, bonding strength retention rate, and laser transmittance deviation, and thus may have high laser transmittance, excellent laser transmission stability due to low laser transmittance deviation according to injection conditions, and excellent long-term durability due to excellent hydrolysis resistance.

In detail, the resin molded product may include a polyester resin composition containing: (a) a polyester resin including polybutylene terephthalate and polyethylene terephthalate; (b) a filler; (c) a chain extender; (d) a resin modifier; and (e) a catalyst, and the polyester resin composition may contain, based on 100 parts by weight of the polyester resin: (b) 5-200 parts by weight of the filler; (c) 0.01-10 parts by weight of the chain extender; (d) 0.01-10 parts by weight of the resin modifier; (e) 0.01-9 parts by weight of the catalyst, and the polyester resin may include, based on 100 parts by weight of the polyester resin, 10-70 parts by weight of polybutylene terephthalate and 30-90 parts by weight of polyethylene terephthalate, and in this case, the resin molded product may have excellent laser transmittance and laser transmission stability as well as excellent hydrolysis resistance.

Hereinafter, the polyester resin composition will be described in more detail by being divided into each component.

### (a) Polyester Resin

The polyester resin is a base resin contained in the polyester resin composition and includes polybutylene terephthalate (PBT) and polyethylene terephthalate (PET), and specifically, may be a mixture of the polybutylene terephthalate and the polyethylene terephthalate.

### Polybutylene Terephthalate (PBT)

The polybutylene terephthalate is a polyester resin which has a repeating unit represented by Formula 1 below, and has a melting temperature of 215° C. to 235° C.

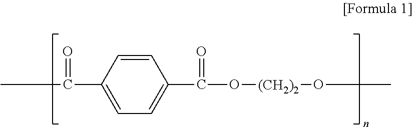

In Formula 1 above, n is an integer of 50 to 200.

The polybutylene terephthalate may have an intrinsic viscosity (IV, η) of 0.6 dl/g to 1.8 dl/g measured according to ASTM D2857, and specifically, may have an intrinsic viscosity of 0.7 dl/g to 1.3 dl/g or 0.9 dl/g to 1.3 dl/g in consideration of a balanced improvement in processability and mechanical properties of the polyester resin composition containing the polybutylene terephthalate.

In addition, the polybutylene terephthalate may be included in an amount of 10-70 parts by weight based on 100 parts by weight of the polyester resin, and there may occur a limitation in that if the amount of the polybutylene terephthalate is less than the lower limit of the range, a solidification rate is slowed down and a cycle time is lengthened during injection molding of the polyester resin composition including the polybutylene terephthalate, and if the amount is greater than the upper limit of the range, a laser transmittance of the resin molded product obtained by injection molding is significantly reduced, and thus the above-described laser transmittance may not be satisfied.

### Polyethylene Terephthalate (PET)

The polyethylene terephthalate is a polyester resin which has a repeating unit represented by Formula 2 below, and has a melting temperature of 230° C. to 265° C.

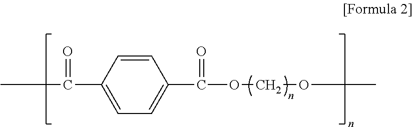

In Formula 2 above, n is an integer of 40 to 160.

The polyethylene terephthalate may have an intrinsic viscosity (IV, η) of 0.5 dl/g to 1.5 dl/g measured according to ASTM D2857, and specifically, may have an intrinsic viscosity of 0.52 dl/g to 1.25 dl/g in consideration of processability and mechanical properties of the polyester resin composition containing the polyethylene terephthalate.

In addition, the polyethylene terephthalate may be included in an amount of 30-90 parts by weight based on 100 parts by weight of the polyester resin, and there may occur a limitation in that if the amount of the polyethylene terephthalate is less than the lower limit of the range, a laser transmittance of the resin molded product obtained by injection molding the polyester resin composition including the polyethylene terephthalate is significantly reduced, and thus the above-described laser transmittance may not be satisfied, and if the amount is greater than the upper limit of the range, a solidification rate is slowed down and a cycle time is lengthened during injection molding of the polyester resin composition including the polyethylene terephthalate.

### (b) Filler

The filler may include a fiber reinforcing material, and specifically, one or more selected from the group consisting of inorganic fibers such as glass fibers, asbestos, carbon fibers, silica fibers, alumina fibers, silica-alumina fibers, aluminum silicate fibers, zirconia fibers, potassium titanate fibers, and silicon carbide fibers; inorganic whiskers such as silicon carbide whiskers, alumina whiskers, and boron nitride whiskers; organic fibers such as aliphatic or aromatic polyamide fibers, aromatic polyester fibers, fluorine-containing resin fibers, and acrylic resin fibers such as polyacrylonitrile; a plate-shaped reinforcing material such as talc, mica, plate glass, and graphite; a fine particle-reinforcing material such as glass beads, glass powder, and milled glass fibers; and wollastonite in the form of a plate, column, or fiber.

In addition, the fiber reinforcing material may have an average diameter of 1-50 μm, or 3-30 μm, and an average length of 100 μm to 3 mm, 300 μm to 1 mm, or 500 μm to 1 mm. In addition, the plate-shaped or fine particle reinforcing material may have an average particle size of 0.1-100 μm, 0.1-50 μm, or 0.1-10 μm.

In addition, the filler may be used alone or in combination of two or more, specifically, the filler may be a glass fiber, a glass flake, a glass bead, talc, mica, wollastonite or a potassium titanate fiber, and more specifically, the filler may be a glass fiber, in particular, a chopped strand product.

As another example, the filler may be a glass fiber, and in this case, the cross-section of the glass fiber may have a circular, rectangular, oval, dumbbell, or diamond shape, and may have an average diameter of 7-20 μm or 7-15 μm, and an average length of 2-6 mm or 3-6 mm.

In addition, the filler may be included in an amount of 5-200 parts by weight, specifically, 10-100 parts by weight, based on 100 parts by weight of the polyester resin composition, and when the amount of the filler is less than the lower limit of the range, an effect of improving heat resistance and mechanical properties due to addition of the filler may be insignificant, and when the amount is greater than the upper limit of the range, the surface gloss may be greatly reduced.

### (c) Chain Extender

In an embodiment of the present invention, the chain extender may be an epoxy group-containing compound which provides effects of mitigating a reduction in molecular weight due to hydrolysis of the polyester resin composition and reducing a decrease in physical properties due to hydrolysis.

Specifically, the chain extender may be at least one compound containing a glycidyl functional group as an example, and may be a glycidyl (meth)acrylate-based compound as a specific example.

Specific examples of the glycidyl methacrylate-based compound may include glycidyl (meth)acrylate, ethylene glycidyl (meth)acrylate, a noblock type glycidyl resin, and the like, and may be selected from the group consisting of a combination of compounds including glycidyl.

In addition, the chain extender may be included in an amount of 0.01-10 parts by weight, specifically 0.1-5 parts by weight, based on 100 parts by weight of the polyester resin.

### (d) Resin Modifier

In an embodiment of the present invention, the resin modifier may be an aromatic group-containing carbodiimide-based compound that serves to suppress hydrolysis reaction by end-capping a carboxyl group (COOH) at the end of a polyester resin.

Specifically, the aromatic group-containing carbodiimide-based compound may be, for example, a phenyl group-containing carbodiimide resin. In addition, when the aromatic group-containing carbodiimide-based compound is used as the resin modifier, an imide end group thereof serves as an acid scavenger to cap the carboxyl groups at the ends of the polymers constituting the polyester resin, thereby suppressing hydrolysis reaction.

The resin modifier may be included in an amount of 0.01-10 parts by weight, specifically 3-10 parts by weight, based on 100 parts by weight of the polyester resin. When included in the range, the resin modifier may maintain excellent mechanical properties by preventing deterioration of mechanical properties due to hydrolysis resistance.

### (e) Catalyst

In an embodiment of the present invention, the catalyst may serve as a catalyst for activating a reaction between the chain extender and the end group of the polyester resin, and may be a hindered amine light stabilizer (HALS)-based weakly basic catalyst.

The catalyst may be included in an amount of 0.01-9 parts by weight, specifically 0.1-4 parts by weight, based on 100 parts by weight of the polyester resin.

### (f) Organic-Based Nucleating Agent

In addition, according to an embodiment of the present invention, the polyester resin composition may further include (f) an organic-based nucleating agent, and in this case, (f) the organic-based nucleating agent may be included in an amount of less than 5 parts by weight based on 100 parts by weight of the polyester resin.

In the present invention, the organic-based nucleating agent may contribute to the improvement of solidification rate during injection molding a polyester resin composition including the organic-based nucleating agent, thereby serving to reduce cycle time, and at the same time, assist in improving laser transmittance deviation so that the resin molded product obtained by injection molding the composition has a uniform laser transmittance in general.

The organic-based nucleating agent may be a metal salt-based crystallizing agent, and specifically, may be a reaction product produced by reacting sodium ionomer and a metal-based silicate.

In addition, the organic-based nucleating agent may be in the form of particulate or plate, may have an average particle diameter of 0.01-10 μm, or 0.02-5 μm, and may be included in an amount 0-5 parts by weight (exclusive of 0) based on 100 parts by weight of the polyester resin.

### (g) Other Additives

In addition, according to an embodiment of the present invention, the polyester resin composition may further include a typical additive as long as it does not affect required properties thereof, and the additive may be, for example, an antioxidant, a heat stabilizer, a light stabilizer, an ultraviolet absorbing additive, a matting agent, a plasticizer, a mold releasing agent, an antistatic agent, a flame retardant, an anti-drip agent, a radiation stabilizer, a mold releasing agent, or a combination thereof. In addition, when the additive is included, each additive may be included in an amount of 5 parts by weight or less, or 0.001-5 parts by weight based on 100 parts by weight of the polyester resin.

### Camera Module Member

In addition, the present invention provides a camera module member including the resin molded product.

The camera module member may be a barrel or a rear body.

The camera module member according to the present invention is manufactured by using the above-described resin molded product as a laser transmissive material for laser welding, and thus, may have excellent bonding strength due to excellent laser welding properties, and may have excellent long-term durability due to excellent hydrolysis resistance.

### Automobile Electronic Component Member

In addition, the present invention provides an automobile electronic component member including the resin molded product. Here, automobile electronic components may include all electronic devices installed in the vehicle.

The automobile electronic component member according to the present invention is manufactured by using the above-described resin molded product as a laser transmissive material for laser welding, and thus, may have excellent bonding strength due to excellent laser welding properties, and may have excellent long-term durability due to excellent hydrolysis resistance.

### Example

Hereinafter, the present invention will be described in more detail according to examples. However, the example according to the present invention may be modified in many different forms, and the scope of the present invention should not be interpreted to be limited to the examples described below. Rather, the example of the present invention is provided so that this description will be thorough and complete, and will fully convey the scope of the present invention to those skilled in the art.

Hereinafter, the compound used in the example is included in the corresponding materials described above, and commercially available materials are used, and exemplary specific features are as follows:

(1) Polybutylene terephthalate resin (PBT): a polybutylene terephthalate resin having a weight average molecular weight (Mw) of 10,000 g/mol to 80,000 g/mol

(2) Polyethylene terephthalate resin (PET): a polyethylene terephthalate resin including at least one derived-unit selected from among 1,4-cyclohexanedimethanol and isophthalic acid

(3) Filler: a glass fiber (containing 1-40 wt % of aluminum oxide, 10-60 wt % of calcium oxide, and 5 wt % or less of at least one selected from among iron oxide, magnesium oxide, sodium oxide, iron and boron oxide)

(4) Chain extender: an epoxy group-containing compound

(5) Resin modifier: an aromatic group-containing carbodiimide-based compound

(6) Catalyst: a hindered amine light stabilizer (HALS)-based weakly basic catalyst

(7) Organic-based nucleating agent: a metal salt-based crystallizing agent

(8) Other stabilizers: antioxidants

### Example

The resin composition was prepared by uniformly mixing each component with a super mixer at a composition ratio shown in Table 1 below, and then melt-kneading was performed at 250° C. using a twin-screw extruder to prepare pellets by extrusion. After the pellets were dried at 100° C. for at least 5 hours, the resin molded product was prepared by molding the pellets at an injection pressure of 30 to 70 in an injection temperature range of 220° C. to 280° C. and a mold range of 40° C. to 100° C. using an LS 170-ton injection machine.

TABLE 1

| Division (parts by weight) | Example 1 |
|---|---|
| PBT | 40.1 |
| PET | 26.7 |
| Filler | 30 |
| Chain extender | 1.5 |
| Resin modifier | 1.5 |
| Catalyst | 0.3 |
| Organic-based nucleating agent | 0.2 |
| Stabilizer | 1.0 |

In Table 1 above, each of parts by weight is represented based on 100 parts by weight of the resin composition.

### Comparative Example 1

TRIPET®2550G30LW (Samyang Co., Ltd.) material was used as a material of Comparative Example 1.

### Comparative Example 2

Lupox®GP2300M (LG CHEM) material was used as a material of Comparative Example 2.

### Comparative Example 3

Lupox®LZ5300B (LG CHEM) material was used as a material of Comparative Example 3.

### Experimental Example 1

Laser transmittance, laser transmittance standard deviation, and laser welding performance of the resin molded product of Example and the materials of Comparative Examples 2 and 3 were compared and analyzed, and the results are shown in Table 2 below.

### (1) Laser Transmittance (%)

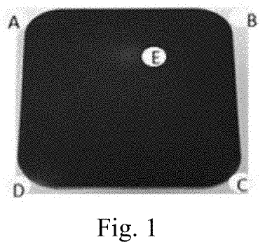

A rectangular specimen having 60 mm (width)×60 mm (length)×1.5 mm (thickness) was prepared by injection molding a resin molded product and a material as shown in FIG. 1, and the laser beam was emitted onto the specimen at a laser irradiation wavelength of 980 nm and an output of 10 mW using ETM-31 (EV Laser Co., Ltd.) for the gate part (E) and four positions (A to D), which are not the gate part, respectively, and then the returned intensity value was measured, and the laser transmittance was calculated by Equation 5 below.

In addition, in this case, the laser transmittance was measured five times for each part, and in Table 2, the laser transmittance of the gate part is the average value of the laser transmittance measurement values of the gate part, and the maximum transmittance is the average value of the total laser transmittance measurement values at the four positions except for the gate part.

T (laser transmittance (%))=100×P_{T}/P₀ [Equation 5]

In Equation 5 above, P_{T} is a laser output (mW) through the specimen, and P₀ is 10 mW.

### (2) Laser Transmittance Standard Deviation

The standard deviation was obtained from the total laser transmittance measurement values, obtained in (1) above, of the gate part and the four positions other than the gate part of each rectangular specimen.

### (3) Laser Welding Performance

A rectangular specimen having 60 mm (width)×60 mm (length)×1.5 mm (thickness) was prepared by injection molding the resin molded product, placed on a laser absorbing material (a resin obtained by adding carbon black to the resin composition of Example), and laser welding is performed. Then, a load (pressure) was measured at the time when the bonding site was separated was measured using a UTM device (3367, INSTRON, Co., Ltd.) when the load was applied at a speed of 5 mm/min, and the measured value was evaluated as the maximum value of the bonding strength.

TABLE 2

| | | | Comparative | Comparative |
|---|---|---|---|---|
| Division | | Example | Example 2 | Example 3 |
| Laser | Gate part | 88.4 | 23.3 | 42.0 |
| transmittance (%) | Maximum | 94.3 | 29.4 | 93.4 |
| | transmittance | | | |
| Laser transmittance | | 2.4 | 2.5 | 20.6 |
| standard deviation | | | | |
| Laser welding | 30 W | 3650 | X | 3705 |
| performance | 40 W | 3805 | X | 3710 |
| (N) | 50 W | 3970 | 485 | 3875 |

Referring to Table 2, it was confirmed that the resin molded product of Example has remarkably excellent laser transmittance regardless of the measured portion, has little difference in the laser transmittance between the measured portions, and has improved laser welding performance.

On the other hand, in the case of the material of Comparative Example 2, the laser transmittance and the welding performance were very poor, and in the case of the material of Comparative Example 3, the laser transmittance of the gate part was significantly reduced, and the laser transmittance stability was poor due to significant difference in the laser transmittance between the measured portions.

From the above results, it was confirmed that the laser transmittance and laser transmittance standard deviation of the resin molded product according to an embodiment of the present invention satisfies at least a specific value, and thus the laser stability is excellent.

### Experimental Example 2

The durability of the resin molded products prepared in Example and Comparative Examples as laser welding materials was compared and analyzed, and the results are shown in Table 3 below.

### (1) Preparation of Laser Welding Material

Each of the resin molded products [60 mm (width)×60 mm (length)×1.5 mm (thickness)] was placed on a laser absorbing member (a resin obtained by adding carbon black to the resin composition of Example) in 60 mm (width)×60 mm (length)×1.5 mm (thickness), and laser-welded at a wavelength of 980 nm to prepare a rectangular specimen having a bonding site of 60 mm (length)×1.5 mm (thickness).

### (2) Tensile Strength (Mpa)

According to IZOD 527, a load (pressure) was measured at the time when an Instron tensile tester was used to pull the specimen at a speed of 5 mm/min and the specimen was then broken.

### (3) Flexural Strength (MPa), Flexural Modulus (MPa), and Flexural Strength Retention Rate (%)

Measurement was performed according to MS216-06 standard. When a load was applied at a speed of 2 mm/min using a UTM device (3367, INSTRON, Co., Ltd.) to the specimen, the load (pressure) was measured at the time when the bonding site was bent and ruptured.

In addition, flexural strength retention rate 1 was obtained by Equation 1 below, and flexural strength retention rate 2 was obtained by Equation 3 below.

Flexural strength retention rate (%)=[FS₁/FS₀]×100 [Equation 1]

In Equation 1 above, FS₀ is the flexural strength measured at a speed of 2 mm/min immediately after preparation of each specimen, and FS₁ is the flexural strength measured at a speed of 2 mm/min after leaving each specimen at 120° C. and 100% RH for 96 hours. Here, 120° C. and 100% RH are conditions formed using a pressure cooker tester (PCT), which is equipment called HAST.

Flexural strength retention rate A (%)=[FS₂/FS₀]×100 [Equation 3]

In Equation 3 above, FS₀ is the flexural strength measured at a speed of 2 mm/min immediately after preparation of each specimen, and FS₂ is the flexural strength measured at a speed of 2 mm/min after leaving each specimen at 120° C. and 100% RH for 144 hours. Here, 120° C. and 100% RH are conditions formed using a pressure cooker tester (PCT), which is equipment called HAST.

### (4) Bonding Strength (N) and Bonding Strength Retention Rate (%)

Measurement was performed according to MS216-06 standard. When a load was applied at a speed of 5 mm/min using a UTM device (3367, INSTRON, Co., Ltd.) to the specimen, the load (pressure) was measured at the time when the bonding site was separated.

In addition, bonding strength retention rate 1 was obtained by Equation 2 below, bonding strength retention rate 2 was obtained by Equation 4 below.

Bonding strength retention rate (%)=[BS₁/BS₀]×100 [Equation 2]

In Equation 2 above, BS₀ is the bonding strength measured at a speed of 5 mm/min immediately after preparation of each specimen, and BS₁ is the bonding strength measured at a speed of 5 mm/min after leaving each specimen at 120° C. and 100% RH for 96 hours. Here, 120° C. and 100% RH are conditions formed using a pressure cooker tester (PCT), which is equipment called HAST.

Bonding strength retention rate A (%)=[BS₂/BS₀]×100 [Equation 4]

In Equation 4 above, BS₀ is the bonding strength measured at a speed of 5 mm/min immediately after preparation of each specimen, and BS₂ is the bonding strength measured at a speed of 5 mm/min after leaving each specimen at 120° C. and 100% RH for 144 hours. Here, 120° C. and 100% RH are conditions formed using a pressure cooker tester (PCT), which is equipment called HAST.

TABLE 3

| | | Compar- | Compar- | Compar- |
|---|---|---|---|---|
| | | ative | ative | ative |
| Division | Example | Example 1 | Example 2 | Example 3 |
| Tensile strength (MPa) | 155 | 123 | 140 | 154 |
| Flexural strength (MPa) | 211 | 171 | 205 | 208 |
| Flexural strength | 59 | 25 | 35 | 31 |
| retention rate 1 (%) | | | | |
| Flexural strength | 35 | 20 | 24 | 20 |
| retention rate 2 (%) | | | | |
| Flexural modulus (MPa) | 8820 | 7580 | 8300 | 8960 |
| Bonding strength (N) | 3770 | 3290 | 480 | 2950 |
| Bonding strength | 54 | 7 | — | 25 |
| retention rate 1 (%) | | | | |
| Bonding strength | 29 | 6 | — | 15 |
| retention rate 2 (%) | | | | |

Referring to Table 3 above, it may be seen that the resin molded product of Example has excellent tensile strength, flexural strength, flexural modulus, and bonding strength, as well as remarkably improved flexural strength retention rate and bonding strength retention rate as compared with the materials of Comparative Examples 1 to 3, and thus the long-term durability is remarkably improved.

From the results of Tables 2 and 3, it was confirmed that the resin molded product according to an embodiment of the present invention has not only excellent laser stability but also excellent long-term durability.

The resin molded product of the present invention has excellent laser transmission stability by satisfying specific conditions with respect to a laser transmittance, a flexural strength retention rate, a bonding strength retention rate, and a laser transmittance deviation, and thus has a high laser transmittance, a low transmittance deviation, and excellent hydrolysis resistance despite changes in injection conditions, thereby having excellent long-term durability.

While the present invention has been shown and described in connection with the exemplary embodiments, it will be apparent to those skilled in the art that modifications and variations can be made without departing from the spirit and scope of the invention as defined by the appended claims.

What is claimed is:

1. A resin molded product having a laser transmittance of 80% or more of a 1.5 mm-thick rectangular-specimen gate part measured at a wavelength of 980 nm, a first flexural strength retention rate of 50% or more, a first bonding strength retention rate of 50% or more, and a laser transmittance standard deviation of 20 or less,
wherein the first flexural strength retention rate satisfies:
first flexural strength retention rate (%)=[FS₁/FS₀]×100,
wherein the first bonding strength retention rate satisfies:
first bonding strength retention rate (%)=[BS₁/BS₀]×100,
wherein FS₀ is a first flexural strength measured at a speed of 2 mm/min, and BS₀ is a first bonding strength measured at a speed of 5 mm/min, the first flexural strength FS₀ and the first bonding strength BS₀ being measured immediately after preparation of a specimen having a bonding site having a length of 60 mm and a width of 1.5 mm, which is prepared by laser-welding the resin molded product and a laser absorbing member at a wavelength of 980 nm, and
wherein FS₁ is a second flexural strength measured at a speed of 2 mm/min, and BS₁ is a second bonding strength measured at a speed of 5 mm/min, the second flexural strength FS₁ and the second bonding strength BS₁ being measured after leaving the specimen at 120° C. and 100% RH for 96 hours.

2. The resin molded product of claim 1, wherein the first bonding strength BS₀ is 2500 N or greater.

3. The resin molded product of claim 1, wherein the first flexural strength FS₀ is 9,000 MPa or greater.

4. The resin molded product of claim 1, wherein a maximum laser transmittance of the 1.5 mm-thick rectangular specimen measured at the wavelength of 980 nm is 90% or greater.

5. The resin molded product of claim 1, wherein the resin molded product has a second flexural strength retention rate of 30% or more, the second flexural strength retention rate satisfying:
second flexural strength retention rate (%)=[FS₂/FS₀]×100,
wherein FS₂ is a third flexural strength measured at a speed of 2 mm/min after leaving the specimen at 120° C. and 100% RH for 144 hours.

6. The resin molded product of claim 1, wherein the resin molded product has a second bonding strength retention rate of 30% or more, the second bonding strength retention rate satisfying:
second bonding strength retention rate (%)=[BS₂/BS₀]×100,
wherein BS₂ is a third bonding strength measured at a speed of 5 mm/min after leaving the specimen having the bonding site at 120° C. and 100% RH for 144 hours.

7. The resin molded product of claim 1, wherein the resin molded product comprises a polyester resin composition containing:
a polyester resin including polybutylene terephthalate and polyethylene terephthalate;
a filler;
a chain extender;
a resin modifier; and
a catalyst.

8. The resin molded product of claim 7, wherein the polyester resin composition containing, based on 100 parts by weight of the polyester resin:
the filler of 5-200 parts by weight;
the chain extender of 0.01-10 parts by weight;
the resin modifier of 0.01-10 parts by weight; and
the catalyst of 0.01-9 parts by weight.

9. The resin molded product of claim 7, wherein the resin composition further contains an organic-based nucleating agent at an amount of less than 5 parts by weight based on 100 parts by weight of the polyester resin.

10. The resin molded product of claim 7, wherein the polyester resin contains 10 to 70 parts by weight of polybutylene terephthalate and 30 to 90 parts by weight of polyethylene terephthalate.

11. The resin molded product of claim 7, wherein the chain extender comprises a glycidyl (meth)acrylate-based compound.

12. The resin molded product of claim 7, wherein the resin modifier comprises an aromatic group-containing carbodiimide-based compound.

13. The resin molded product of claim 7, wherein the catalyst comprises a hindered amine light stabilizer-based weakly basic catalyst.

14. A camera module member comprising the resin molded product of claim 1.

15. An automobile electronic component member comprising the resin molded product of claim 1.
